(19) United States
(12) Patent Application Publication
(10) Pub. No.: US 2026/0131578 A1
(43) Pub. Date: May 14, 2026

(54) DRYING DEVICE

(71) Applicant: SEIKO EPSON CORPORATION, Tokyo (JP)

(72) Inventor: Hiroki AOKI, MATSUMOTO-SHI (JP)

(21) Appl. No.: 19/383,975

(22) Filed: Nov. 10, 2025

(30) Foreign Application Priority Data
Nov. 11, 2024 (JP) 2024-196864

(51) Int. Cl. B41J 11/00; B41J 2/01

(52) U.S. Cl. CPC B41J 11/00222; B41J 2/01; B41J 11/0021; B41J 11/00224

(57) ABSTRACT

A drying device 10 that dries a medium M on which an image is recorded with ink containing a high boiling point solvent having a higher boiling point than water, the drying device 10 including a drying oven 14, a heating section 15 that heats the medium M in the drying oven 14, an exhaust section 16 that exhausts vapor generated by heating the medium M from the drying oven 14, wherein the exhaust section 16 includes the duct 13 extending from the drying oven 14, an aggregation member 163 that is disposed to block an air flow flowing in the duct 13 and condenses vapor exhausted from the exhaust section 16, and a collection section 164 that collects liquid condensed on the aggregation member 163.

The present application is based on, and claims priority from JP Application Serial Number 2024-196864, filed November 11, 2024, the disclosure of which is hereby incorporated by reference herein in its entirety.

### BACKGROUND

### 1. Technical Field

The present disclosure relates to a drying device.

### 2. Related Art

In the related art, various printing systems that print an image on a medium by ejecting ink have been used. Among these, there is a medium having a drying device that dries ink applied to a medium. For example, JP-A-2008-110588 discloses a drying device for drying inkjet printed textile. The drying device of JP-A-2008-110588 has a configuration capable of bringing the inside of a chamber, which accommodates a fabric roll that was dyed using inkjet printing, into a reduced pressure state by a pressure reducing machine in order to dry the textile roll and remove a high boiling point solvent.

In many cases, a high boiling point solvent such as glycerin is contained in the ink. In a general drying device, ink is evaporated and the vapor of the ink including the high boiling point solvent is often discharged to the outside of the device. If the high boiling point solvent leaks in the device, there is a risk of failure, and a burden of cleaning and maintenance is generated. The drying device of JP-A-2008-110588 includes a trapping device capable of cooling ink to liquefy or solidify the ink by mixing the ink vapor with a cooling medium such as ice, dry ice, or liquefied nitrogen, and the trapping device can trap and collect the volatilized high boiling point solvent. It is also possible to improve the recovery efficiency by installing a heater in the chamber to heat the textile roll.

In this way, in various printing systems that print an image on a medium by ejecting ink, there are cases in which it is desirable to collect the high boiling point solvent contained in the ink. However, the trapping device is large and expensive. The introduction of the trapping device complicates the device configuration. This is because it may be difficult for the trapping device to separate the high boiling point solvent contained in the ink from the cooling medium, because the vapor of the ink and the cooling medium are mixed. Therefore, it has been difficult to suitably collect the high boiling point solvent in the ink with a simple configuration.

### SUMMARY

A drying device according to the present disclosure for solving the above-described problem is a drying device that dries a medium on which an image is recorded with ink that contains a high boiling point solvent having a higher boiling point than water, the drying device including a drying oven; a heating section configured to heat the medium in the drying oven; and an exhaust section configured to exhaust vapor generated by heating the medium from the drying oven, wherein the exhaust section includes a duct extending from the drying oven, an aggregation member that is disposed to block an air flow flowing in the duct and that is configured to aggregate vapor exhausted from the exhaust section, and a collection section configured to collect liquid condensed on the aggregation member.

### BRIEF DESCRIPTION OF THE DRAWINGS

FIG. 1 is a schematic side view illustrating a printing system according to a first embodiment of the present disclosure.

FIG. 2 is a schematic diagram illustrating an exhaust section of a drying device constituting the printing system of FIG. 1.

FIG. 3 is a schematic bottom view illustrating an aggregation member and a fan of the exhaust section of FIG. 2.

FIG. 4 is a schematic perspective view illustrating the aggregation member and the fan of the exhaust section of FIG. 2.

FIG. 5 is a perspective view illustrating a fan applicable to the drying device of the present disclosure.

FIG. 6 is a perspective view illustrating a fan having a configuration different from that of the fan in FIG. 5 and applicable to the drying device of the present disclosure.

FIG. 7 is a perspective view illustrating a fan having a configuration different from those of the fans in FIGS. 5 and 6, and applicable to the drying device of the present disclosure.

FIG. 8 is a perspective view illustrating a fan having a configuration different from those of the fans in FIGS. 5 to 7 and applicable to the drying device of the present disclosure.

FIG. 9 is a perspective view illustrating a fan having a configuration different from those of the fans in FIGS. 5 to 8 and applicable to the drying device of the present disclosure.

FIG. 10 is a schematic diagram illustrating an exhaust section of a drying device included in a printing system according to a second embodiment of the present disclosure.

FIG. 11 is a schematic diagram illustrating an exhaust section of a drying device constituting a printing system according to a third embodiment of the present disclosure.

### DESCRIPTION OF EMBODIMENTS

First, the present disclosure will be schematically described.

A drying device according to a first aspect of the present disclosure for solving the above problem is a drying device that dries a medium on which an image is recorded with ink that contains a high boiling point solvent having a higher boiling point than water, the drying device including a drying oven; a heating section configured to heat the medium in the drying oven; and an exhaust section configured to exhaust vapor generated by heating the medium from the drying oven, wherein the exhaust section includes a duct extending from the drying oven, an aggregation member that is disposed to block an air flow flowing in the duct and that is configured to aggregate vapor exhausted from the exhaust section, and a collection section configured to collect liquid condensed on the aggregation member.

According to the present aspect, the exhaust section including the duct extending from the drying oven, the aggregation member disposed to block the air flow flowing in the duct and condensing the vapor exhausted from the exhaust section, and the collection section collecting the liquid condensed on the aggregation member is provided. With such a configuration, the high boiling point solvent in the ink can be suitably collected with a simple configuration without using an expensive device that is difficult to introduce, such as a trapping device.

Drying device of a second aspect of the present disclosure is an aspect according to the first aspect, wherein the aggregation member is a plate member that is rotatable in a state of facing the air flow.

According to the present aspect, the aggregation member is a plate member that is rotatable in a state of facing the air flow. With such a configuration, the aggregation member can have a particularly simple configuration.

Drying device of a third aspect of the present disclosure is an aspect according to the first or second aspect, wherein the plate member has a curved structure on a front surface thereof, the curved structure curving from a rotation shaft side toward an outer side and toward a downstream side in a rotation direction.

According to the present aspect, the plate member has a curved structure on the front surface that curves downstream side in the rotation direction from the rotation shaft side toward the outside. By adopting such a configuration, the high boiling point solvent can be efficiently collected to the outside, and the high boiling point solvent in the ink can be particularly suitably collected.

Drying device of a fourth aspect of the present disclosure is an aspect according to the first aspect, wherein

The air current flows upward, and the aggregation member has a front surface in which a central section is located higher than the end section when viewed from below.

According to the present aspect, the aggregation member has a front surface in which the central section is positioned higher than the end section when viewed from below. With such a configuration, the aggregation member can have a particularly simple configuration.

Drying device of a fifth aspect of the present disclosure is an aspect according to the fourth aspect, wherein the aggregation member is rotatable about a rotation shaft extending in a vertical direction.

According to the present aspect, the aggregation member is rotatable with the vertical direction as a rotation shaft. By adopting such a configuration, the high boiling point solvent can be efficiently collected to the outside, and the high boiling point solvent in the ink can be particularly suitably collected.

A drying device according to a sixth aspect of the present disclosure is an aspect according to any one of the first to fifth aspects, wherein the collection section is provided over the entire circumference of the inner wall of the duct.

According to the present aspect, the collection section is provided over the entire circumference of the inner wall of the duct. With such a configuration, the high boiling point solvent can be collected in a wide region in the duct, and the high boiling point solvent in the ink can be particularly suitably collected.

A drying device according to a seventh aspect of the present disclosure is an aspect according to any one of the first to sixth aspects, wherein

When viewed in the vertical direction, the aggregation member is arranged such that at least a portion of it overlaps the collection section and is located below it.

According to the present aspect, the aggregation member disposed above the collection section is provided in an arrangement in which at least a portion thereof overlaps the collection section when viewed in the vertical direction. With such a configuration, the high boiling point solvent can be efficiently moved from the aggregation member to the collection section using gravity, and the high boiling point solvent in the ink can be particularly suitably collected.

Drying device of eighth aspect of the present disclosure is an aspect according to any one of the first to seventh aspects, wherein the exhaust section includes a fan that is rotated by the air flow, and the aggregation member is connected to the fan and is driven to rotate by rotation of the fan.

According to this aspect, the exhaust section includes the fan that is rotated by the air flow, and the aggregation member is connected to the fan and is driven to rotate by the rotation of the fan. With this configuration, it is possible to achieve an inexpensive and simple configuration in which the fan and the aggregation member are rotated without separately preparing a drive section such as a motor.

A drying device of a ninth aspect of the present disclosure is an aspect according to any one of the first to seventh aspects, wherein

The aggregation member is rotatable in a state of facing the air flow, and the exhaust section includes a drive section that rotates the aggregation member.

According to this aspect, the aggregation member is rotatable in a state of facing the air flow, and the exhaust section includes the drive section that rotates the aggregation member. With this configuration, the aggregation member can be rotated at a desired rotation speed.

Drying device of a tenth aspect of the present disclosure is an aspect according to the ninth aspect, further includes a rotation load detection section configured to detect a rotational load of the aggregation member and a control section that controls drive force by the drive section so as to change a number of rotations per unit time of the aggregation member based on a detection result of the rotation load detection section.

According to the aspect, the rotation speed per unit time of the aggregation member is changed based on the detection result of the rotation load detection section capable of detecting the rotation load of the aggregation member. With such a configuration, the aggregation member can be continuously rotated at a desired rotation speed.

A drying device of an eleventh aspect of the present disclosure is an aspect according to any one of the first to seventh aspects, wherein the exhaust section includes a fan connected to the aggregation member and a drive section that rotates the fan.

According to the aspect, the exhaust section includes the fan connected to the aggregation member and the drive section that rotates the fan. With this configuration, the aggregation member can be rotated at a desired rotation speed together with the fan.

Drying device of a twelfth aspect of the present disclosure is an aspect according to the eleventh aspect, further includes a temperature detection section configured to detect temperature in the duct, and a control section that controls drive force by the drive section so as to change rotation speed per unit time of the fan based on a detection result of the temperature detection section.

According to the present aspect, the rotation speed per unit time of the fan is changed based on the detection result of the temperature detection section capable of detecting the temperature in the duct. With this configuration, the aggregation member can be continuously rotated at a desired rotation speed together with the fan.

Drying device of a thirteenth aspect of the present disclosure is an aspect according to any one of the first to twelfth aspects, wherein the exhaust section includes a connection section disposed between the drying oven and the duct and a cooling section that is disposed between the connection section and the aggregation member and that is configured to cool inside the duct.

According to the present aspect, the exhaust section includes the connection section between the drying oven and the duct, and the cooling section disposed between the connection section and the aggregation member and configured to cool the inside of the duct. With such a configuration, it is possible to efficiently cool the volatile component of the ink such as the high boiling point solvent by cooling the inside of the duct by the cooling section, and it is possible to particularly suitably collect the high boiling point solvent in the ink.

Drying device of a fourteenth aspect of the present disclosure is an aspect according to the thirteenth aspect, wherein the cooling section is an opening section penetrating the duct from the inside to the outside.

According to the present aspect, the cooling section is an opening section that penetrates through both the interior and exterior of the duct. With such a configuration, the cooling section can have a simple configuration.

Drying device is an aspect according to a fifteenth aspect of the present disclosure to the fourteenth aspect, further includes a temperature detection section configured to detect a temperature in the duct and a control section configured to control size of an opening area of the opening section based on a detection result of the temperature detection section.

According to the present aspect, the size of the opening area of the opening section is controlled based on the detection result of the temperature detection section capable of detecting the temperature in the duct. With such a configuration, the aggregation member can be efficiently cooled in the cooling section, and the high boiling point solvent can be efficiently cooled.

Drying device of a sixteenth aspect of the present disclosure is an aspect according to the thirteenth aspect, wherein

The cooling section is a path section that is provided on an inner side surface of the duct and is capable of circulating a liquid.

According to the present aspect, the cooling section is a path section that is provided on the inner side surface of the duct and is capable of circulating the liquid. With such a configuration, the high boiling point solvent can be efficiently cooled by the liquid circulating in the path section.

Drying device of a seventeenth aspect of the present disclosure is an aspect according to the sixteenth aspect, further includes a temperature detection section configured to detect a temperature in the duct and a control section configured to control an amount of the liquid circulated in the path section based on a detection result of the temperature detection section.

According to the present aspect, the amount of the liquid circulated in the path section is controlled based on the detection result of the temperature detection section configured to be capable of detecting the temperature in the duct. With such a configuration, the high boiling point solvent can be continuously cooled efficiently.

### FIRST EMBODIMENT

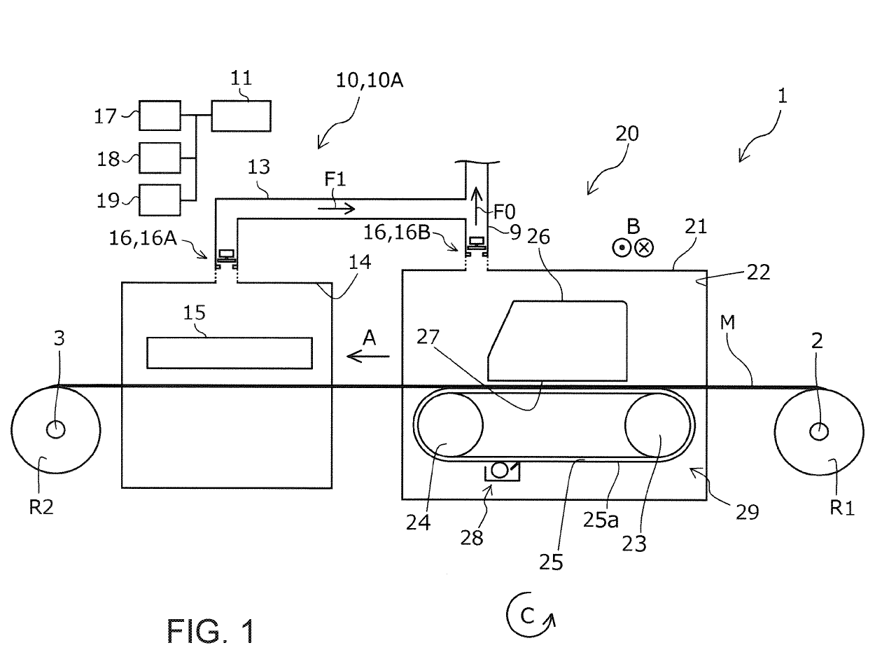

Hereinafter, embodiments according to the present disclosure will be described with reference to the drawings. First, an overview of a printing system 1 including a printing device 20 and a drying device 10A according to a first embodiment, which is an example of a drying device 10, will be described with reference to FIG. 1.

As illustrated in FIG. 1, a printing system 1 according to the embodiment includes a holding section 2 that can rotatably hold a roll body R1, around which a medium M such as textiles is wound in the form of a roll. The printing device 20 includes the transport section 29 that transports the medium M, a head 27 as a printing section that prints an image by ejecting ink onto the medium M transported by the transport section 29, and a housing 21 having the first space 22 in which the head 27 is disposed. The drying device 10A of the present embodiment includes a drying oven 14 into which the medium M on which images have been printed by the head 27, and the heating section 15 that is disposed in the drying oven 14 and that heats the medium M. The printing system 1 further includes a winding section 3 that can form a roll body R2 by winding, into a roll shape, the medium M on which printing was performed by the printing device 20 and the ink of which was dried by the drying device 10A.

The holding section 2 holds a paper tube that constitutes a rotation shaft of the R1 of the roll body, and rotates in a rotation direction C to feed the medium M from the R1 of the roll body to the transport section 29 of the printing device 20. It should be noted that the holding section 2 may be configured separately from the printing device 20, but may be a portion of the constituent member of the printing device 20.

The printing device 20 of the present embodiment is an inkjet printer capable of forming an image on a medium M by ejecting ink, which is a liquid, in the form of droplets. The printing device 20 includes, as a transport section 29 that is in a first space 22 inside the housing 21, a driven roller 23 located on the upstream side in a transport direction A, which is the transport direction of the medium M, a drive roller 24 located on the downstream side in the transport direction A, and a transport belt 25, which is an endless belt stretched between the driven roller 23 and the drive roller 24. The transport belt 25 is an adhesive belt having an outer peripheral surface 25a whose support surface, which is the outer surface, for the medium M is coated with an adhesive. A washing section 28 capable of washing the outer peripheral surface 25a is provided inside the housing 21. A duct 9 for discharging the gas in the first space 22 is connected to the housing 21.

As illustrated in FIG. 1, in the transport section 29, the medium M are transported while being supported by the transport belt 25 in a state in which the medium M is attached to the outer peripheral surface 25a. In the printing device 20 according to this embodiment, a medium support region of the transport belt 25, which supports the medium M, is an upper side region of the transport belt 25, which is wound around the driven roller 23 and the drive roller 24. The drive roller 24 is a roller that rotates in a rotation direction C by drive force of a motor (not illustrated), and the driven roller 23 is a roller that rotates by being driven by the rotation of the transport belt 25 according to the rotation of the drive roller 24.

That is, the movement direction of the transport belt 25 when transporting the medium M is the rotation direction C, and the movement direction of the transport belt 25 at the medium supporting region is the transport direction A. However, except when transporting the medium M, it is also possible to rotate the drive roller 24 in the direction opposite to the rotation direction C and move the transport belt 25 in the direction opposite to the rotation direction C.

The printing device 20 of the present embodiment includes a carriage 26 that can reciprocate in the transport belt 25 width direction B of the transport belt 25, and the head 27 attached to the carriage 26. The head 27 is a printing section that can, based on the print data, form an image by ejecting liquid ink onto the medium M transported in the transport direction A. It should be noted that the ink ejected from the head 27 of the present embodiment contains, in addition to the color material, water as the main solvent and a high boiling point solvent having a boiling point higher than that of water, such as glycerin. It should be noted that the type of the high boiling point solvent is not particularly limited, and polyhydric alcohols such as glycerin, and other various solvents that dissolve in water as the main solvent and have a higher boiling point than water can be used alone or in combination.

The printing device 20 of the embodiment can form an image by ejecting ink from the head 27 onto the transported medium M while reciprocating the carriage 26 in the width direction B intersecting the transport direction A. By including the carriage 26 having such a configuration, the printing device 20 of the embodiment can form a desired image on the medium M by repeating transport of the medium M in the transport direction A by a predetermined transport amount and ejection of ink while moving the carriage 26 in the width direction B in a state where the medium M is stopped. However, the configuration of the printing section is not particularly limited. For example, a so-called line head in which nozzles that eject ink are provided over the entire width direction B of the medium M may be used as the printing section.

When the medium M on which an image is formed by ejecting ink from the head 27 is discharged from the printing device 20 of the present embodiment, the medium M is sent to a drying device 10A that is provided at a stage subsequent to the printing device 20 of the present embodiment in the transport direction A and that volatilizes components of the ink ejected onto the medium M. The drying device 10A of the present embodiment constitutes the printing system 1 together with the printing device 20.

Here, as the medium M, a textile print material can be desirably used. Textile print material refers to fabric, clothing, other garment products, and the like that are the target of printing. Fabrics include woven fabrics, knitted fabrics, and nonwoven fabrics made of natural fibers such as cotton, silk, and wool, chemical fibers such as nylon, or composite fibers mixed with these fibers. Clothing and other garment products include sewn T-shirts, handkerchiefs, scarves, towels, handbags, fabric bags, curtains, sheets, bed covers, and other furniture, as well as fabric before and after cutting, which exists as parts before being sewing together. However, in addition to the above-mentioned textile print material to be printed on, specialized paper dedicated for ink jet recording such as plain paper, woodfree paper, and glossy paper can also be used.

As illustrated in FIG. 1, the drying device 10A of the present embodiment includes a heating section 15 that heats the medium M, and the drying oven 14 in which the heating section 15 is disposed and that dries the medium M. In the present embodiment, the heating section 15 is configured to blow a heated air flow to the medium M. However, the configuration of the heating section 15 is not particularly limited, and may be a configuration in which the medium M is irradiated with infrared rays, a heater formed of a heating wire, or the like. However, the heating temperature of the medium M by the heating section 15 needs to be a temperature higher than the boiling point of the high boiling point solvent in the ink.

A duct 13 is attached to the drying oven 14, an airflow generation section for generating an air flow is provided in the duct 13, and the air flow flows in the direction F1 in the duct 13. Since the direction F1 is a direction from the drying device 10A toward the outside, the duct 13 constitutes an exhaust section 16 (exhaust section 16A) to be described later. The duct 9 is attached to the printing device 20, an airflow generation section for generating an air flow is provided in the duct 9, and the air flow flows in the direction F0 in the duct 9. Since the direction F0 is a direction from the printing device 20 toward the outside, the duct 9 also constitutes the exhaust section 16 (exhaust section 16B). In the present embodiment, the duct 13 and the duct 9 merge with each other, but the duct 13 and the duct 9 may not merge with each other. It should be noted that in the printing system 1 of the present embodiment, the exhaust section 16A of the drying device 10A and the exhaust section 16B of the printing device 20 have the same configuration, but the configuration is not limited thereto.

As described above, the printing system 1 of the present embodiment includes the winding section 3. The winding section 3 holds a paper tube as a rotation shaft for forming the roll body R2, and rotates in a rotation direction C to wind the medium M around the paper tube, thereby forming the roll body R2. It should be noted that the winding section 3 may be configured separately from the drying device 10A, but may be a portion of a constituent member of the drying device 10A.

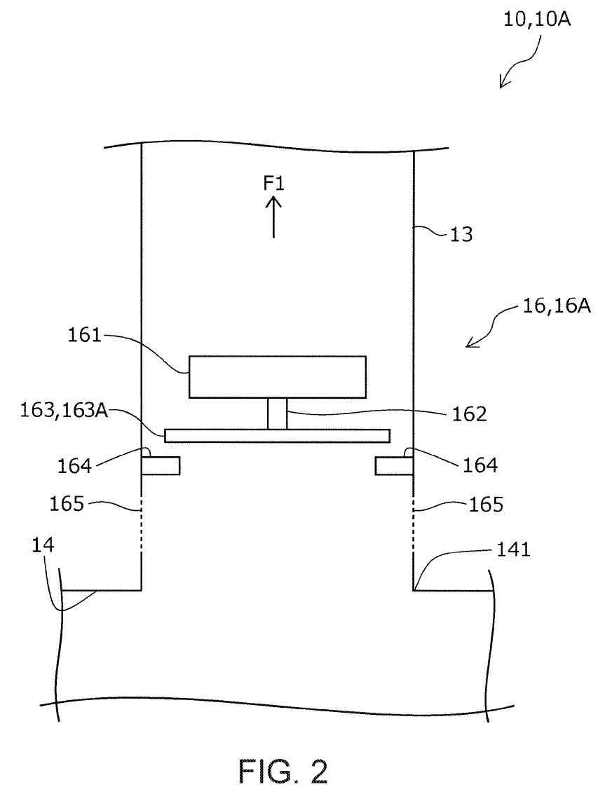

As described above, the drying device 10A constituting the printing system 1 of the present embodiment is the drying device 10 that dries the medium M on which images are recorded with ink containing a high boiling point solvent having a higher boiling point than water. The drying device 10A includes the drying oven 14, the heating section 15 that, in the drying oven 14, heats the medium M at a temperature higher than the boiling point of the high boiling point solvent, and the exhaust section 16A that exhausts, from the drying, oven vapor generated by heating the medium M. Here, the details of the exhaust section 16A of the present embodiment will be described below with reference to FIGS. 2 to 9.

As illustrated in FIG. 2, the exhaust section 16A includes the duct 13 extending from the drying oven 14, an aggregation member 163 that is disposed so as to block the air flow flowing in the duct 13 and that condenses the vapor discharged from the exhaust section 16A, and a collection section 164 that collects the liquid that is the volatile components of the ink condensed on the aggregation member 163. As illustrated in FIG. 2, the end section of the aggregation member 163 overlaps the collection section 164 in the vertical direction, and the liquid condensed on the aggregation member 163 drips from the end section of the aggregation member 163 to the collection section 164. The configuration of the collection section 164 is not particularly limited, and may be, for example, an absorbing member capable of absorbing and holding a liquid.

The drying device 10A of the present embodiment has such a configuration, and thus it is possible to suitably recover the high boiling point solvent in the ink with a simple configuration without using a device which is expensive and difficult to introduce, such as a trapping device. Here, condensation of liquid on the aggregation member 163 means not only the condensation of vaporized high boiling point solvent but also the adhesion of the high boiling point solvent in a liquid state in the water vapor or the like and the adhesion of the high boiling point solvent in a liquid state to the collection section together with the water vapor or the like. The heating section 15 of the present embodiment is configured to be able to heat the medium M at a temperature higher than the boiling point of the high boiling point solvent in the drying oven 14, but is not limited to such a configuration. For example, the medium M may be heated by high-frequency dielectric heating by generating an alternating electric field from 3MHz to 300MHz and by microwave heating by generating an alternating electric field from 300M to 30GHz.

It should be noted that it is also conceivable to recover the high boiling point solvent by disposing a filter or the like that serves as both the aggregation member 163 and the collection section 164 so as to block the air flow flowing in the duct 13, but in such a configuration, the filter needs to be frequently replaced. By adopting the configuration of the present embodiment in which the aggregation member 163 and the collection section 164 are separately provided, the high boiling point solvent such as glycerin accumulated in the collection section 164 needs to be collected each time, but the frequency of replacement of the aggregation member 163 can be reduced.

In the printing system 1 of the present embodiment, as described above, the printing device 20 is also provided with the exhaust section 16A that has the same configuration as the exhaust section 16B. Therefore, in the printing system 1 of the present embodiment, the high boiling point solvent in the ink can be suitably collected with a simple configuration even in the printing device 20. However, the present disclosure is not limited to a configuration in which the exhaust section 16 is also provided in the printing device 20.

Here, the aggregation member 163 of the exhaust section 16A of the present embodiment is a disk-shaped plate member 163A as illustrated in FIGS. 2 to 4. Specifically, the plate member 163A is a disk-shaped flat plate made of porous stainless steel (SUS). The plate member 163A is configured to be rotatable in a rotation direction D1 with respect to a rotation shaft 162 in a state of facing the air flow in the duct 13. The drying device 10A of the present embodiment has such a configuration, and thus the aggregation member 163 can have a particularly simple configuration.

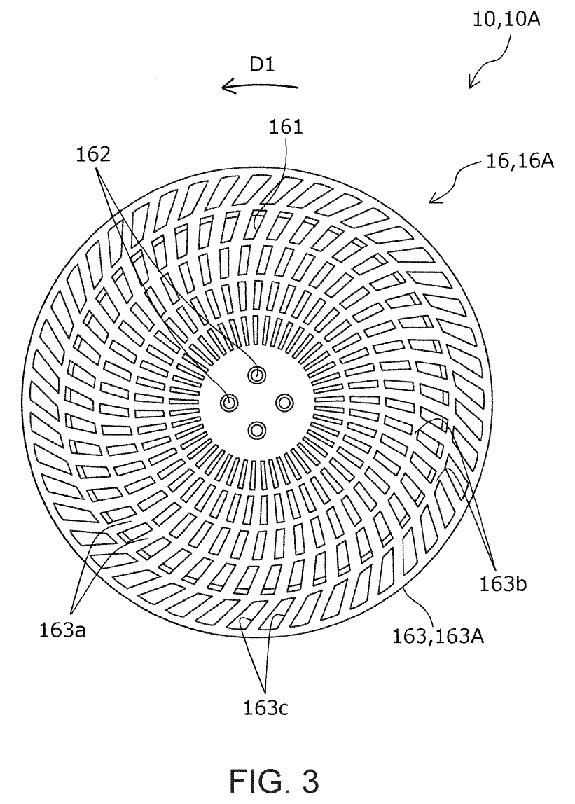

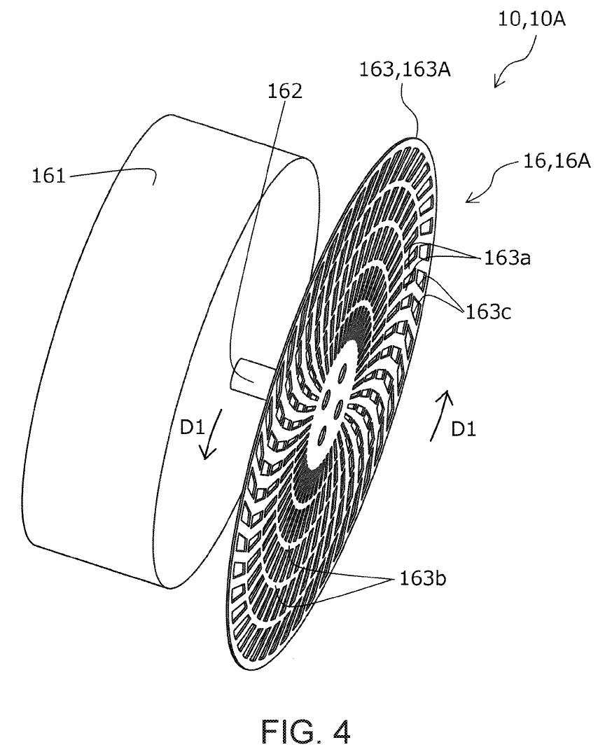

More specifically, as illustrated in FIGS. 3 and 4, the plate member 163A is configured of a plurality of first extending sections 163a extending from the rotation shaft 162 toward the outside, and second extending sections 163b extending in the rotation direction D1. Here, the first extending sections 163a bends from the rotation shaft 162 side toward the outside to the downstream side in the rotation direction D1. The first extending sections 163a and the second extending sections 163b form hole sections 163c through which air flow can pass.

In other words, the plate member 163A has, on its front surface, a curved structure that is curved downstream in the rotation direction D1 from the rotation shaft 162 side toward the outside. The drying device 10A of the present embodiment is configured as described above, and thus it is possible to efficiently collect the high boiling point solvent at the outside of the plate member 163A, and it is possible to particularly suitably recover the high boiling point solvent in the ink.

In the drying device 10A of the present embodiment, the duct 13 in the region illustrated in FIG. 2 has an annular shape as viewed from the vertical direction. Similarly to the duct 13, the collection section 164 also has an annular shape as viewed from the vertical direction. That is, the collection section 164 of the present embodiment is provided over the entire inner circumference of the exhaust section 16A of the duct 13. The drying device 10A of the present embodiment is configured as described above, and thus it is possible to collect the high boiling point solvent in a wide region in the duct 13, and it is possible to particularly suitably collect the high boiling point solvent in the ink. However, the present disclosure is not limited to such a configuration, and the duct 13 in the region illustrated in FIG. 2 may have a rectangular frame shape when viewed from the vertical direction, and the collection section 164 may also have a rectangular frame shape when viewed from the vertical direction.

As described above, in the drying device 10A of the present embodiment, the collection section 164 is provided below the aggregation member 163, and when viewed in the vertical direction, the end section of the aggregation member 163 overlaps the collection section 164. In other words, when viewed from the direction F1 in which the air flow flows, the aggregation member 163 is provided in an arrangement in which at least a portion of it overlaps the collection section 164. The drying device 10A of the present embodiment is configured as described above, and thus it is possible to efficiently move the high boiling point solvent from the aggregation member 163 to the collection section 164 using gravity, and it is possible to particularly suitably recover the high boiling point solvent in the ink.

As illustrated in FIGS. 2 to 4, the exhaust section 16A of the present embodiment includes a fan 161 connected to the aggregation member 163 by a rotation shaft 162. The rotation shaft 162 serves as a rotation shaft of the aggregation member 163 and also serves as a rotation shaft of the fan 161. The fan 161 is configured to be rotatable by an air current flowing through the duct 13 in the direction F1. The aggregation member 163 is configured to be driven to rotate by the rotation of the fan 161 connected thereto. By adopting a configuration in which the aggregation member 163 can be driven to rotate in accordance with the rotation of the fan 161 rotated by the air flow flowing in the duct 13, for example, it is possible to adopt an inexpensive and simple configuration in which the fan 161 and the aggregation member 163 are rotated without separately preparing a drive section such as a motor.

On the other hand, as illustrated in FIG. 1, the drying device 10A of the present embodiment includes a control section 11 and a drive section 17 capable of driving the fan 161 under the control of the control section 11. As described above, the aggregation member 163 is rotatable in a state of facing the air flow, but the exhaust section 16A of the present embodiment is configured to be capable of rotating the aggregation member 163 by the drive force of the drive section 17. With such a configuration, the aggregation member 163 can be rotated at a desired rotation speed. That is, the drying device 10A of the present embodiment can rotate the fan 161 by the air flow that flows in the duct 13 by turning off the drive of the drive section 17, and can rotate the fan 161 and the aggregation member 163 at a desired rotation speed by turning on the drive of the drive section 17.

It should be noted that the drive section 17 of the present embodiment is configured to be able to rotate the aggregation member 163 together with the fan 161. However, the present disclosure is not limited to such a configuration. For example, the fan 161 may not be provided, and the drive section 17 may be configured to rotate only the aggregation member 163.

As illustrated in FIG. 1, the drying device 10A of the present embodiment includes a rotation load detection section 18 capable of detecting a rotation load of the fan 161 that corresponds to a rotation load of the aggregation member 163. The control section 11 controls the drive force of the drive section 17 so as to change the number of revolutions of the fan 161 that corresponds to the number of revolutions per unit time of the aggregation member 163 based on the detection result of the rotation load detection section 18. The drying device 10A of the present embodiment is configured as described above, and thus the fan 161 and the aggregation member 163 can be continuously rotated at a desired rotation speed.

In the drying device 10A of the present embodiment, as illustrated in FIG. 2, the exhaust section 16A includes a connection section 141 between the drying oven 14 and the duct 13, and an opening section 165 as a cooling section that is disposed between the connection section 141 and the aggregation member 163 (specifically, between the connection section 141 and the collection section 164) and is configured to cool the inside of the duct 13. The drying device 10A of the present embodiment is configured to include such a cooling section, and thus, the volatile components of the ink such as the high boiling point solvent can be efficiently cooled by using the cooling section to cool the inside of the duct 13, and the high boiling point solvent in the ink can be particularly suitably collected.

Specifically, the cooling section provided on the exhaust section 16A of the present embodiment is an opening section 165 penetrating through inside to outside of the duct 13. By configuring the cooling section in this manner, the cooling section can be configured simply. However, the configuration of the cooling section is not particularly limited, and in addition to the configuration of the opening section 165, a method of water-cooling the inside of the duct 13, a method of cooling the inside of the duct 13 with a peltier element, a method of cooling the inside of the duct 13 with a compressor, or the like can be used.

As illustrated in FIG. 1, the drying device 10A of the present embodiment includes a temperature detection section 19 capable of detecting the temperature in the duct 13. The drying device 10A of the present embodiment is configured to be able to change the size of the opening area of the opening section 165 based on the detection result of the temperature detection section 19 by an opening area adjustment mechanism (not illustrated) under the control of the control section 11. The drying device 10A of the present embodiment has such a configuration, and thus the aggregation member 163 in the duct 13 can be efficiently cooled by the cooling section, and the high boiling point solvent can be efficiently cooled.

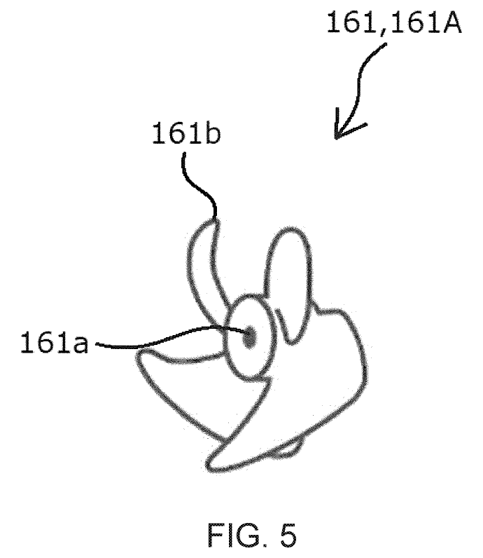

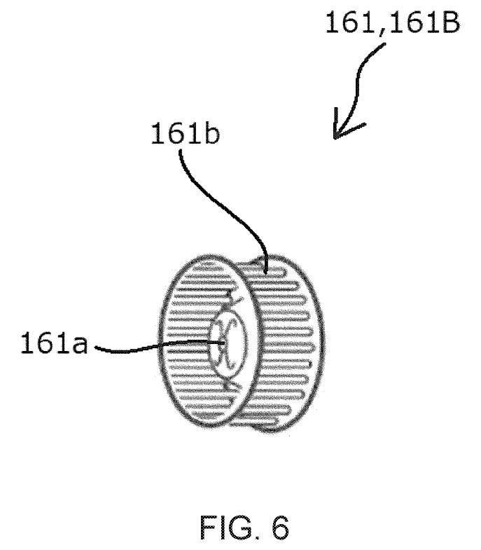

It should be noted that, as illustrated in FIG. 5, the exhaust section 16A of the present embodiment includes, as the fan 161, a propeller fan 161A having a bearing 161a through which the rotation shaft 162 passes and a plurality of blade sections 161b provided on the bearing 161a. However, the configuration of the fan 161 is not particularly limited. For example, as illustrated in FIG. 6, the fan 161 may include a sirocco fan 161B having a bearing 161a through which the rotation shaft 162 passes and a plurality of blade sections 161B provided on the bearing 161a.

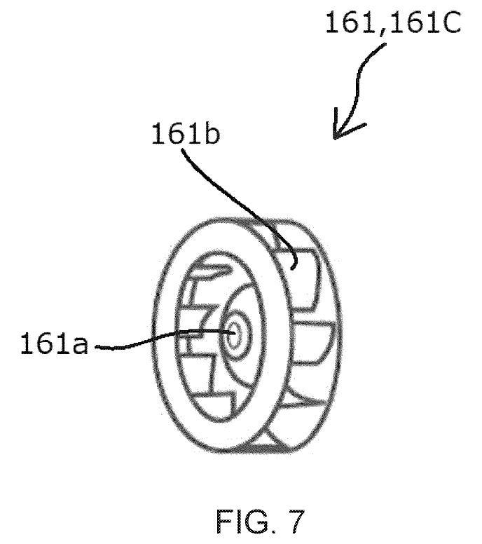

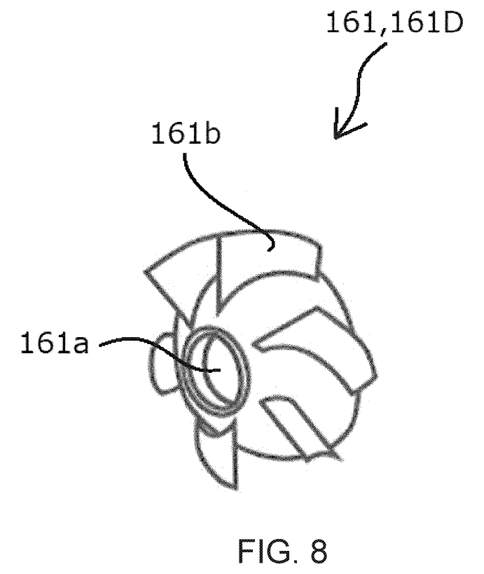

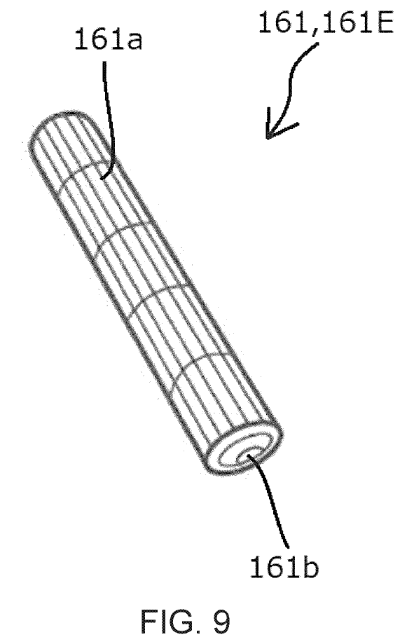

For example, as illustrated in FIG. 7, a turbo fan 161C having a bearing 161a through which the rotation shaft 162 passes and a plurality of blade sections 161b provided on the bearing 161a may be provided as the fan 161. For example, as illustrated in FIG. 8, the fan 161 may include a mixed flow duct fan 161D having a bearing 161a through which the rotation shaft 162 passes and a plurality of blade sections 161b provided on the bearing 161a. For example, as illustrated in FIG. 9, a line flow fan (registered trademark) 161E having a bearing 161a through which the rotation shaft 162 passes and a plurality of blade sections 161b provided on the bearing 161a may be provided as the fan 161.

### SECOND EMBODIMENT

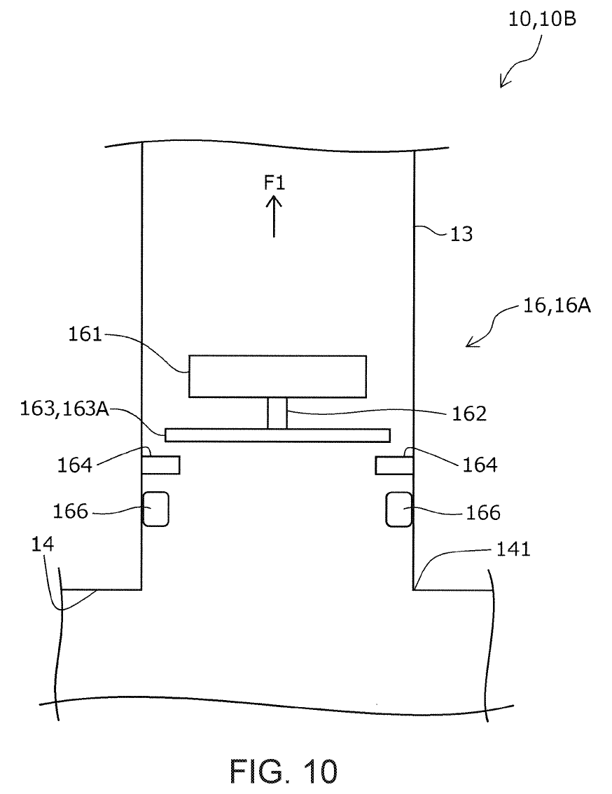

Next, the drying device 10B of the second embodiment will be described with reference to FIG. 10. It should be noted that FIG. 10 corresponds to FIG. 2 of the printing system 1 according to the first embodiment. In FIG. 10, components common to those of the first embodiment are denoted by the same reference numerals, and detailed description thereof will be omitted. Here, the drying device 10B of the present embodiment has the same configuration as the drying device 10A of the first embodiment except for the portions described below. Therefore, the drying device 10B of the present embodiment has the same features as the drying device 10A of the first embodiment except for the portions described below.

As can be seen from comparison between FIG. 2 and FIG. 10, the drying device 10B of the present embodiment is different from the drying device 10A of the first embodiment only in the configuration of the cooling section. To be specific, the cooling section in the drying device 10B of the present embodiment is a path section 166 that is provided on the inner side surface of the duct 13 and is capable of circulating water as a liquid. It should be noted that when viewed from the vertical direction, the path section 166 is disposed to go around the inner side surface of the duct 13. The drying device 10B of the present embodiment is configured to have such a water-cooled cooling section, and thus the high boiling point solvent can be efficiently cooled by the liquid (water) circulating through the path section 166. It should be noted that as a matter of course, since the path section 166 is sealed, the liquid circulating through the path section 166 and the component contained in the volatilized ink do not mix together.

The drying device 10B of the present embodiment also includes the temperature detection section 19 capable of detecting the temperature in the duct 13, similarly to the drying device 10 of the first embodiment. The drying device 10B of the present embodiment can control the amount of the liquid circulated in the path section 166 based on the detection result of the temperature detection section 19 under the control of the control section 11. The drying device 10B of the present embodiment is configured as described above, and thus can continue to efficiently cool the high boiling point solvent.

### THIRD EMBODIMENT

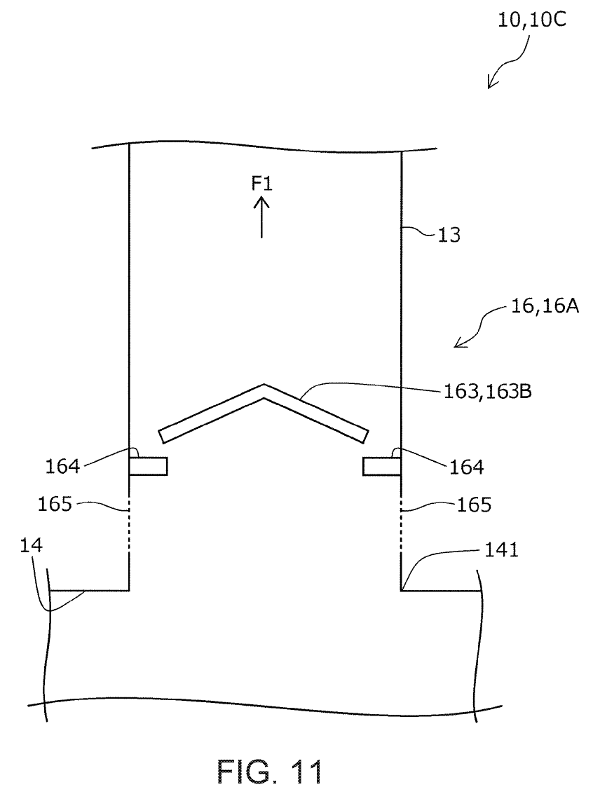

Next, a drying device 10C of the third embodiment will be described with reference to FIG. 11. It should be noted that FIG. 11 corresponds to FIG. 2 of the printing system 1 according to the first embodiment. In FIG. 11, constituent members common to those of the first embodiment are denoted by the same reference symbols, and a detailed description thereof will be omitted. Here, the drying device 10C of the present embodiment has the same configuration as the drying device 10A of the first embodiment except for the portions described below. Therefore, the drying device 10C of the present embodiment has the same features as the drying device 10A of the first embodiment except for the portions described below.

As illustrated in FIG. 11, in the drying device 10C of the present embodiment, the air flow flows in the direction F1, which is the upward direction, similarly to the drying device 10A of the first embodiment, and the aggregation member 163B has a front surface in which the central section, as viewed from below, is positioned above the end section. When viewed from below, the end section of the aggregation member 163B overlap the collection section 164 in the vertical direction, and the condensation components derived from the ink condensed on the aggregation member 163B flow from the central section to the end section and drop from the end section to the collection section 164. The drying device 10C of the present embodiment has such a configuration, and thus the aggregation member 163B can have a particularly simple configuration.

In the drying device 10C of the present embodiment, the aggregation member 163B is configured to be rotatable about a rotation shaft extending in the vertical direction. The drying device 10C of the present embodiment is configured as described above, and thus it is possible to efficiently collect the high boiling point solvent at the end section, which is to the outside of the aggregation member 163B, and it is possible to particularly suitably collect the high boiling point solvent in the ink.

It should be noted that the present disclosure is not limited to the above described embodiments, and various modifications can be made within the scope of the disclosure described in the claims, and it goes without saying that these are also included within the scope of the present disclosure. For example, in the configuration of the second embodiment, when the liquid circulating through the path section 166 is warmed inside the duct 13, the warmed liquid may be used as the cleaning liquid used in the washing section 28. For example, it is also possible to improve the supportability of the medium M by irradiating the medium M before being supported by the transport belt 25 with the vapor after the high boiling point solvent is collected by the exhaust section 16.

What is claimed is:

1. A drying device that dries a medium on which an image is recorded with ink that contains a high boiling point solvent having a higher boiling point than water, the drying device comprising:
a drying oven; a heating section configured to heat the medium in the drying oven; and an exhaust section configured to exhaust vapor generated by heating the medium from the drying oven, wherein
the exhaust section includes a duct extending from the drying oven, an aggregation member that is disposed to block an air flow flowing in the duct and that is configured to aggregate vapor exhausted from the exhaust section, and a collection section configured to collect liquid condensed on the aggregation member.

2. The drying device according to claim 1, wherein
the aggregation member is a plate member that is rotatable in a state of facing the air flow.

3. The drying device according to claim 2, wherein
the plate member has a curved structure on a front surface thereof, the curved structure curving from a rotation shaft side toward an outer side and toward a downstream side in a rotation direction.

4. The drying device according to claim 1, wherein
the air flow flows in an upward direction and
the aggregation member has a front surface in which a central section, as viewed from below, is located above an end section.

5. The drying device according to claim 4, wherein
the aggregation member is rotatable about a rotation shaft extending in a vertical direction.

6. The drying device according to claim 1, wherein
collection section is provided over the entire circumference of the inner wall of the duct.

7. The drying device according to claim 1, wherein
the collection section is provided below the aggregation member and
when viewed in the vertical direction, the aggregation member is provided in an arrangement in which at least a portion of the aggregation member overlaps the collection section.

8. The drying device according to claim 1, wherein
the exhaust section includes a fan that is rotated by the air flow and
the aggregation member is connected to the fan and is driven to rotate by rotation of the fan.

9. The drying device according to claim 1, wherein
the aggregation member is rotatable while facing the air flow and
the exhaust section includes a drive section that rotates the aggregation member.

10. The drying device according to claim 9, further comprising:
a rotation load detection section configured to detect a rotational load of the aggregation member and
a control section that controls drive force by the drive section so as to change a number of rotations per unit time of the aggregation member based on a detection result of the rotation load detection section.

11. The drying device according to claim 1, wherein
the exhaust section includes a fan connected to the aggregation member and a drive section that rotates the fan.

12. The drying device according to claim 11, further comprising:
a temperature detection section configured to detect temperature in the duct, and a control section that controls drive force by the drive section so as to change rotation speed per unit time of the fan based on a detection result of the temperature detection section.

13. The drying device according to claim 1, wherein
the exhaust section includes a connection section disposed between the drying oven and the duct and a cooling section that is disposed between the connection section and the aggregation member and that is configured to cool inside the duct.

14. The drying device according to claim 13, wherein
the cooling section is an opening section penetrating the duct from the inside to the outside.

15. The drying device according to claim 14, further comprising:
a temperature detection section configured to detect a temperature in the duct and a control section configured to control size of an opening area of the opening section based on a detection result of the temperature detection section.

16. The drying device according to claim 13, wherein
the cooling section is a path section that is provided on an inner side surface of the duct and that is capable of circulating a liquid.

17. The drying device according to claim 16, further comprising:
a temperature detection section configured to detect a temperature in the duct and a control section configured to control an amount of the liquid circulated in the path section based on a detection result of the temperature detection section.
